(19) United States
(12) Patent Application Publication
(10) Pub. No.: US 2008/0156911 A1
(43) Pub. Date: Jul. 3, 2008

(54) Safety mechanism for closing shredder opening

(75) Inventor: Simon Huang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/878,478

(22) Filed: Jul. 25, 2007

(30) Foreign Application Priority Data
Dec. 31, 2006 (CN) 200620175419.1

(51) Int. Cl. B02C 23/04

(52) U.S. Cl. 241/37.5

(57) ABSTRACT

A safety mechanism for closing the shredder opening is disclosed. The user can lift the shredder with a single hand for cleaning the trash bin. When the shredder is lifted by the user to leave its normal operation position, its power is shut down with the opening closed to ensure the safety of the user.

### BACKGROUND OF THE INVENTION

1. Field of Invention

The invention relates to a shredder and, in particular, to a shredder with a safety mechanism that shuts down its power and closes its opening when it is lifted by the user to leave its normal operation position, thereby ensuring the safety of the user.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

As is well known, the action principle of a shredder for shredding paper is to dispose several cutting blades on two rotary shafts with spacers in between. A motor and a gear box are employed to drive the two parallel rotary shafts that rotate in opposite directions. They provide a shearing force on passing paper to cut it into small stripes. According to the mechanical cutting type, shredders can be classified as stripe-cut shredders and cross-cut shredders. In the former case, the cutting blades are disposed regularly on the rotary shafts and cut the paper along the longitudinal direction into long stripes. Each blade in the latter case has several hook-shaped cutting edges. The blades are disposed in a spiral way on the rotary shafts. In this case, the paper is not only cut along the longitudinal direction into stripes, but also cut in the transverse direction into chips.

In the case of either stripe-cut shredders or cross-cut shredders, they are usually sold with a trash basket or bin for accommodating trash paper. The trash bin is usually in a cylindrical shape with an upward opening. The trash bin is disposed inside the shredder. The paper pieces being cut directly fall into the trash bin. When the trash bin is full, it has to be clean in order not to affect the normal operations of the shredder.

When cleaning the trash bin, the user usually needs to use both hands to remove the shredder. Most of current shredders are provided with a safety switch. That is, the shredder automatically shuts down its power when it is removed from the trash bin to ensure the user's safety. However, the movable board at the shredder opening is not closed. Therefore, the blades inside the shredder are not separated from the environment. The user may carelessly touch the blades and get hurt while cleaning the trash bin. Therefore, it is desirable to improve the safety.

### SUMMARY OF THE INVENTION

An objective of the invention is to provide a safety mechanism that closes the shredder opening. The user can lift the shredder with a single hand for cleaning the trash bin.

Another objective of the invention is to provide a safety mechanism that closes the shredder opening. When the shredder is lifted up by the user from its normal operation position, its power is shut down with the opening closed, thereby ensuring the user's safety.

To achieve the above objectives, one side of the shredder base is pivotally connected with a knob using an axis. The axis is further in touch with a switch. When the shredder is operating in its normal state, the axis keeps the switch electrically conductive. Once the axis rotates as the knob is lifted, it departs from the switch and thus shuts down the electrical power. The other end of the knob is connected to a transmission mechanism. The transmission mechanism controls the board to move between an opening position and a closing position.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the disclosed safety closing mechanism;

FIG. 2 shows the relative positions of all components when the shredder is in its normal operation state and the lower opening is not closed; and

FIG. 3 shows the relative positions of all components when the shredder is lifted and the opening is closed.

### DETAILED DESCRIPTION OF THE INVENTION

The present invention will be apparent from the following detailed description, which proceeds with reference to the accompanying drawings, wherein the same references relate to the same elements.

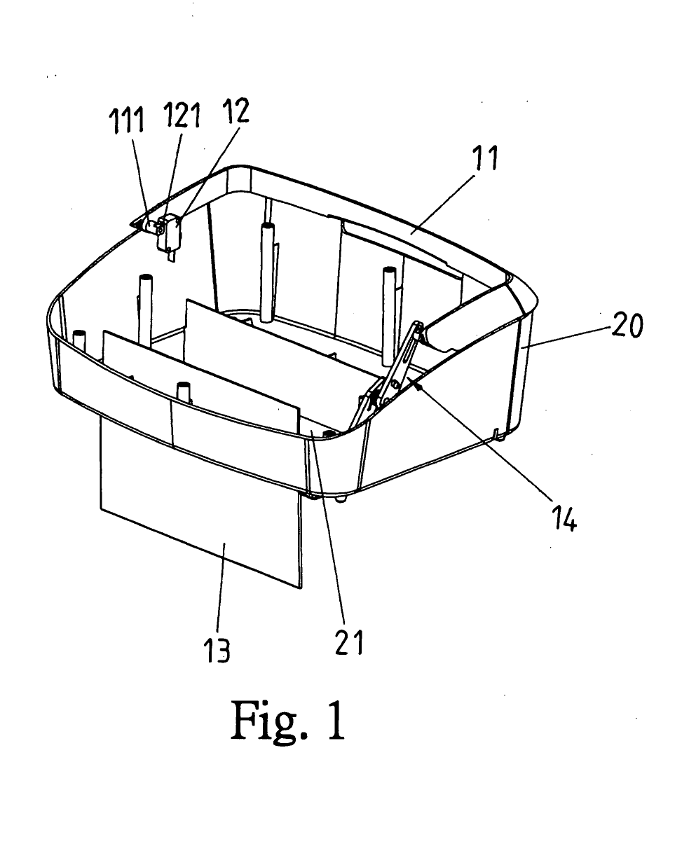

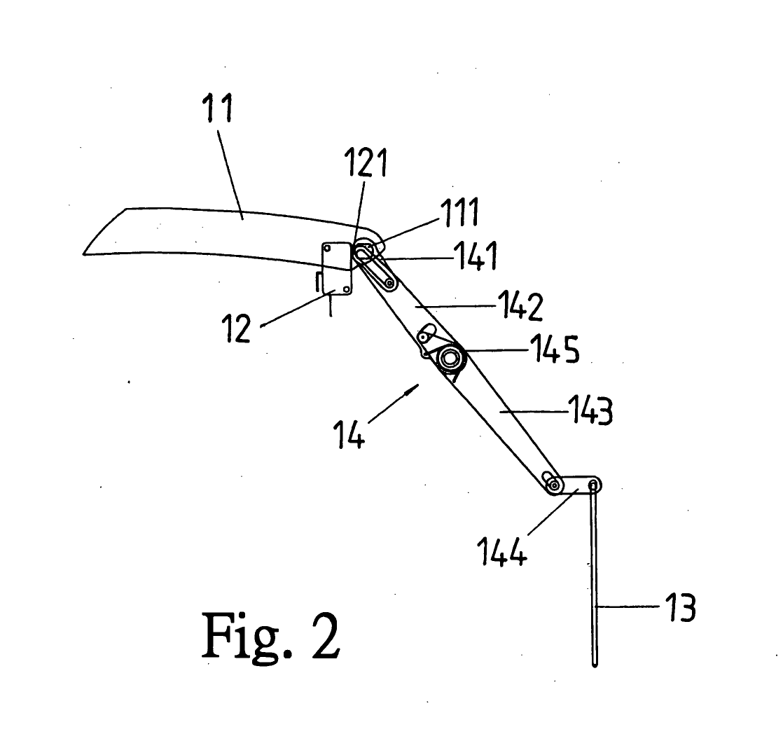

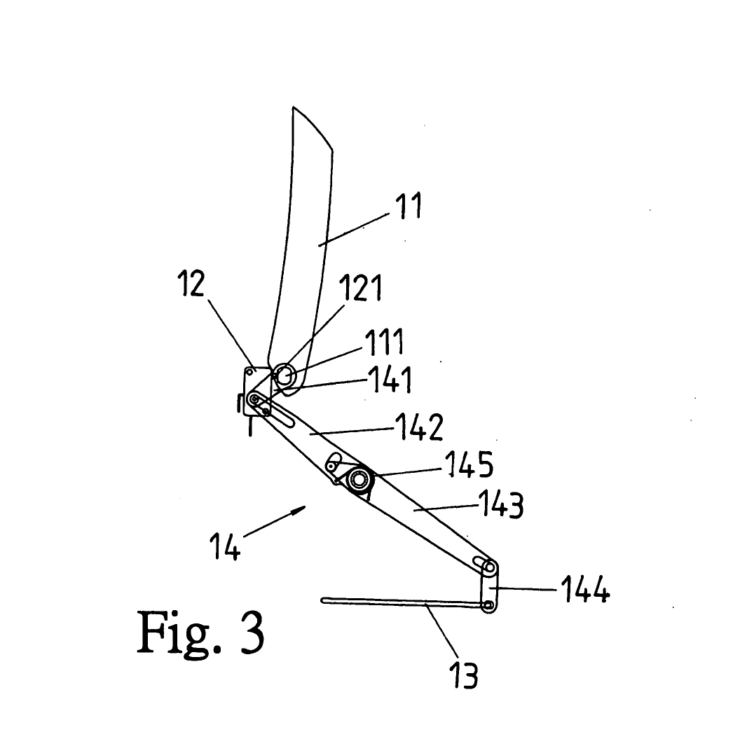

FIG. 1 is a three-dimensional view of the disclosed safety closing mechanism. FIG. 2 shows the relative positions of all components when the shredder is in its normal operation state and the lower opening is not closed. FIG. 3 shows the relative positions of all components when the shredder is lifted and the opening is closed.

As shown in the drawings, one side of the shredder base 20 is pivotally connected with a knob 11 via an axis 111. The axis 111 is in touch with a switch 12 disposed on the top cover (not shown) of the shredder. When the shredder is operating in its normal state, the axis 111 keeps the switch 12 electrically conductive. Once the axis 111 rotates as the knob 11 is lifted up, it departs from the switch 12 and shuts down the electrical power.

The other end of the knob 11 is connected to a transmission mechanism 14. The transmission mechanism 14 controls a board 13 by the opening 21 of the shredder base 20 to move between an opening position and a closing position.

When the shredder is operating in its normal state, the knob 11 is disposed horizontally as in FIG. 2. In this case, one end of the axis 111 of the knob 11 is in touch with a pressing point 121 of the switch 12, so that the shredder can operate normally. When the trash bin is full, the user lifts up the shredder from the trash bin by pulling the knob 11 (FIG. 3). This can be done with a single hand, greatly improved from the prior art. At the same time of pulling up the knob 11, the axis 111 of the knob 11 rotates to change the position of the pressing point 121 that is originally in contact with the switch 11. The shredder is thus shut down.

Also at the same time of pulling the knob 11 up, the transmission mechanism 14 connected to the other end of the knob 11 moves the board 13 from its opening position to a closing position. The blades inside the shredder are thus separated from the exterior. The user is then free from any possible injury due to careless touch of the blades.

The transmission mechanism 14 is basically a four-shaft structure. A first shaft 141 has one end fixed to the knob 11 and the other end pivotally connected to a second shaft 142, driving the second shaft 142 to have a displacement. The other end of the second shaft 142 is pivotally connected to a third shaft 143 via a torque spring 145. Therefore, even though the second shaft 142 and the third shaft 143 are kept in a fixed shape, there is still some flexibility in the connection, preventing the shafts from damages due to friction during the operations. The third shaft 143 is pivotally connected with a fourth shaft 144. The other end of the fourth shaft 144 is fixed on the board 13. The force generated by pulling the knob 11 up is transmitted via the four-shaft mechanism to the board 13, moving it from the opening position in FIG. 2 to the closing position in FIG. 3.

During the above-mentioned transmission process, trash paper may fill the gap between the board 13 and the opening 21. This can cause resistance for the board 13 during its closing process. In this case, the buffering effect provided by the torque spring 145 between the second shaft 142 and the third shaft 143 enables the board 13 to keep moving without damaging the shafts. Therefore, the disclosed four-shaft mechanism ensures the stability of the structure.

In summary, the invention enables the user to lift the shredder using a single hand for cleaning the trash bin. When the shredder is lifted away from its normal position, its power is shut down and the opening is closed. Such a design can ensure the safety and provide extra convenience for the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A safety mechanism for closing the shredder opening, comprising:
a shredder base, which has an opening and a knob pivotally installed on its one side;
a knob, whose both ends are pivotally connected to both sides of the shredder base for the user to lift the shredder using a single hand; and
a transmission mechanism, whose one end is connected to the knob to receive a driving force from the knob and whose other end is connected to a board for transmitting the driving force to the board, moving it between an opening position and a closing position.

2. The safety mechanism for closing the shredder opening of claim 1, wherein one side of the shredder bade is pivotally connected with the knob using an axis, the axis is in touch with a switch, so that the axis keeps the switch electrically conductive during normal operations of the shredder and shuts down the power of the switch when the axis rotates as the knob is lifted.

3. The safety mechanism for closing the shredder opening of claim 1, wherein the transmission mechanism is a four-shaft mechanism.

4. The safety mechanism for closing the shredder opening of claim 3, wherein the four-shaft mechanism includes: a first shaft with one end connected to the knob and the other end connected to a second shaft, driving the second shaft to make a displacement; the other end of the second shaft is pivotally connected to a third shaft via a torque spring; the other end of the third shaft is pivotally connected to a fourth shaft; and the other end of the fourth shaft is fixed on the board.

5. The safety mechanism for closing the shredder opening of claim 3, wherein the driving force generated by lifting up the knob drives the board, via the transmission mechanism, to move from the opening position to the closing position.
